(19) United States
(12) Patent Application Publication
(10) Pub. No.: US 2020/0086581 A1
(43) Pub. Date: Mar. 19, 2020

(54) QUASI-SIMULTANEOUS LASER WELDING PROCESS

(71) Applicant: CONSULTENGINEERIP AG, Buonas (CH)

(72) Inventor: Ulrich Gubler, Buonas (CH)

(73) Assignee: CONSULTENGINEERIP AG, Buonas (CH)

(21) Appl. No.: 16/615,967

(22) PCT Filed: May 9, 2018
(86) PCT No.: PCT/EP2018/061965

§ 371 Date: Nov. 22, 2019

(30) Foreign Application Priority Data
May 23, 2017 (DE) 10 2017 111 244.8

(51) Int. Cl. B29C 65/16; B29C 65/00; B23K 26/03; B23K 26/00; B23K 26/06; B23K 26/08; B23K 26/21

(52) U.S. Cl. CPC B29C 65/1661; B29C 66/91216; B29C 66/91221; B29C 66/863; B29C 65/1635; B29C 66/652; G01J 5/0037; B23K 26/034; B23K 26/0006; B23K 26/0643; B23K 26/0884; B23K 26/21; B29C 66/836

(57) ABSTRACT

A method for the quasi-simultaneous welding of at least two types of welding by means of a laser beam, wherein the laser beam originates from a laser optic which is associated with a platform of a delta robot and is guided by a movement of this platform.

### BACKGROUND OF THE INVENTION

The invention concerns a method and a device for quasi-simultaneous laser transmission welding of plastics.

Methods for welding plastics by means of a laser are known from the state of the art. In laser transmission welding, one of the joining partners to be joined or welded is highly transparent to laser beams, while the other joining partner has a high degree of absorption in relation to the laser beam. Thus, the laser beam traversing one joining partner provides local heating at the joint located between the two components. The pressure required for welding is built up in the familiar way by pressing both joining partners together.

Such a laser transmission welding method is described, for example, in DE 10 2004 004 985 A1 and WO 2007 082 992 A1, whereby the laser beam is guided by means of an arrangement comprising several mirrors onto the joining partners to be welded according to both publications.

In such known methods, movable mirrors are usually used, which are equipped with a so-called galvanometer drive. This is often abbreviated as galvo or galvo mirror, which is why known devices of this kind are also known as galvo scanners. Such mirrors with galvanometer drive as well as their use in devices and methods for quasi-simultaneous laser transmission welding of plastics are well known from the state of the art.

The course of the laser beam in such methods is limited in such a way that, seen from the laser, it is always directed by a last mirror arranged in the beam path onto the plastics or joining partners to be welded. Although this mirror can be swivelled by the galvanometer drive, it cannot otherwise change its spatial position. This limitation result in some disadvantages.

For example, beam shading can occur due to high component walls or other sections of one of the joining partners.

Furthermore, existing connections, which are arranged next to or above the weld seam, can lead to beam shading.

In addition, convex components, for example, can have very unfavorable angles of incidence of the laser beam or unfavorable angles between a component surface and the incoming laser beam.

Without addressing the aforementioned disadvantages, the EP 1 048 439 A2 and the EP 2 255 952 A1 propose to arrange the beam output, from which the laser beam emanates, on a robot arm of a well-known articulated arm robot. However, as was also recognized in EP 2 255 952 A1, such an arrangement poses the problem that the robot cannot achieve high speeds.

However, very high speeds are required for quasi-simultaneous laser transmission welding because the laser beam is deflected so quickly between the welding types or guided along the weld seam that the plastic is heated and plasticized simultaneously at all welding types and welding is thus carried out simultaneously at virtually all welding types.

The EP 2 255 952 A1 proposes once again the familiar galvo scanner as an alternative to a beam output provided on the robot arm in order to achieve high speeds. However, this leads to the disadvantages already described.

### SUMMARY OF THE INVENTION

The task of this invention is to overcome the disadvantages arising from the state of the art. In particular, a method and a device for quasi-simultaneous welding of plastics and quasi-simultaneous laser transmission welding shall be provided, which achieve high speeds as well as overcome the limitations of known galvo scanners.

The objects of independent claims and details disclosed herein lead to the solution of the task.

Advantageous embodiments are also described herein and in the subclaims.

The present invention proposes a method for quasi-simultaneous welding of plastics on at least two types of welding location by means of a laser beam (laser transmission welding), whereby the laser beam emanates from a laser optics, which is assigned to a platform of a delta robot and is guided by a movement of this platform.

The plastics or plastic parts to be welded can also be referred to as joining partners.

Delta robots are known from the state of the art and are described below with regard to the inventive device. Thanks to their parallel kinematics, which are explained in more detail below, delta robots can, for example, run contours much faster than articulated robots or other robots.

In the context of this invention, a welding location is, for example, a spot on a weld seam. Preferably, a welding seam is created with the welding method according to the invention. A weld seam always consists of a large number of welding points or can be thought of as a sequence of a large number of individual welding points.

The laser, i.e. the device for generating the laser beam, can be arranged on the platform. In order to make the platform as light as possible, however, the laser is preferably mounted at a different location, for example on a base plate of the delta robot, and is connected to the laser optics via an optical conductor.

In the context of this invention, laser beam guidance is defined as any measure that changes the spatial orientation or spatial course of the laser beam or moves the laser beam. Usually, at least the laser optics are moved for this purpose. However, it can also be considered that movable mirrors deflect the laser beam and thus change its spatial course.

Details are given with regard to the device that was invented.

It can be thought that the laser beam is guided by a combination of the movement of the platform and another movement, which is caused by a motion device assigned to the platform.

Numerous devices can be considered as motion devices. In principle, any device can be considered which is suitable for influencing the spatial orientation of the laser beam. Details are explained with regard to the device in accordance with the invention.

It may be thought that at least one subunit of the motion device is moved relative to the platform to cause further movement. This at least one subunit may, for example, be at least one mirror which is pivotally mounted opposite the platform. A galvo mirror can be thought of here. Furthermore, this at least one subunit can be an element rotatably fixed to the platform on which the laser optics can be fixed or arranged. Both variants are explained below.

In the context of the present invention, a rotatable fixing, as well as a pivotable fixing and a rotatable fixing, is understood to be a fixing which enables the execution of a rotational movement of the respective component.

It can also be thought that at least one subunit is moved by a shaft. In this case, the drive may be located outside the platform to make the platform as light as possible, as will be explained in more detail below in relation to the device.

As mentioned above, it can be thought that the laser beam is deflected by at least one mirror, which is arranged so that it can pivot relative to the platform. Preferably, the at least one mirror is arranged so that it can pivot relative to an imaginary plane within which the platform essentially lies.

Here different swivel movements can be thought of. Preferably, however, a pivoting movement is preferably understood as a rotation, whereby the axis of rotation lies within the aforementioned imaginary plane or is orthogonal to it.

Furthermore, it can be considered to provide several of the above described swivelling mirrors. In particular, two mirrors should be provided. The pivot and rotation axes of these mirrors are preferably arranged orthogonally to each other. The mirrors are preferably arranged in such a way that the laser beam leaving the laser optics is first reflected by a first mirror, whereby the reflected laser beam from this mirror is then reflected by a second mirror. The beam from the second mirror is preferably directed onto the workpieces to be welded. The spatial orientation of the laser beam can be influenced by corresponding rotation or tilting of both mirrors around their axes of rotation in order to reach welding points at a distance from each other.

As already mentioned, the laser optics can be mounted so that it can move relative to the platform to guide the laser beam. For this purpose, the laser optics can be fixed to an element, which in turn is rotatably fixed to the platform. Such an arrangement is to be seen in particular as an alternative to the arrangements described above, comprising at least one mirror.

It can be thought of that a temperature of the plastic is measured by means of a pyrometer, whereby a measuring result is used for the evaluation and/or regulation of the procedure. Here the temperature of the plastic is measured preferably in the area of the welding points or the welding seam.

The temperature can be measured either continuously or at certain times in intervals.

If, for example, it is known which temperature the welding points or the welding seam must have in order to achieve the desired welding success or the condition of the welding seam lies within the desired limits, it can be easily determined by measuring the temperature by means of the pyrometer when the welding method can be terminated. The measured temperature is used directly to control the method. The measured temperature can also be used in any other way to control the method.

Furthermore, the measured temperature, alternatively or complementary, can also be recorded for an evaluation of the method. By measuring the heating of the weld seam over a large number of welding processes and storing the corresponding data, it is possible, for example, to determine at a later point in time within the framework of a comparison whether certain problems occurred during welding or whether certain components have to be sorted out as rejects. The measured temperature can be used in any way for an evaluation.

This invention also includes a device for quasi-simultaneous welding of plastics, comprising a Delta robot with a platform, with laser optics assigned to the platform. This is therefore a device for quasi-simultaneous laser transmission welding.

Delta robots are state-of-the-art parallel kinematic machines. They are used, for example, for handling small objects at high speed. For the structure and function of delta robots, please refer to U.S. Pat. No. 4,976,582.

Delta robots comprise a movable platform, which can be connected to a base plate via three arms, for example. Usually the base plate accommodates a rotary drive for each arm. The arms only comprise struts and passive joints, so they are only moved by the rotation of the respective drive.

The platform of the delta robot is preferably used to guide the laser beam emanating from the laser optics, which has already been described above with regard to the procedure according to the invention.

In the context of this invention, laser optics is understood to mean an arrangement comprising at least one optical component. For example, collimators such as collimator lenses can be considered. Furthermore, components for focusing, e.g. corresponding lenses, can be considered. Alternatively, appropriately curved mirrors can also be considered, which cause collimation and/or focusing. Usually, the laser beam originates from a focusing component which is preceded by a collimator.

The laser, i.e. the component that generates the laser beam, can be arranged on the platform of the delta robot. In order to keep the weight of the platform as low as possible, however, the laser is preferably positioned elsewhere, for example, it can be attached to the base plate. In this case, instead of the entire laser, only the laser optics are arranged on the platform of the delta robot and are connected to the laser via an optical conductor, for example.

The device can therefore be designed in such a way that the platform is assigned a first end of an optical conductor which is connected to the laser optics, whereby a second end of the optical conductor is connected to a laser, whereby this laser is arranged outside the platform.

The optical fibre does not interfere with the movements carried out by the Delta robot platform and the arrangement only slightly increases the weight of the platform, allowing the light platform to perform rapid movements.

The laser optics can be fixed to an element that is rotatably fixed to the platform. It may also be remembered that this element is not fixed directly to the platform but via a second element, the first element being rotatably fixed to the second element and the second element being rotatably fixed to the platform. Such an arrangement can be conveniently provided by a gimbal suspension. The cardanic suspension is a subassembly of a motion device which is capable of influencing the spatial course of the laser beam by its movement. In this case, the motion device can also include drives for the pivot bearings of the gimbal suspension. In addition to a cardanic suspension, other motion devices can also be considered, which have at least one subunit that can be moved relative to the platform in order to influence the spatial course of the laser beam.

By influencing the spatial course of the laser beam both by the movement of the platform and by the further movement caused by the motion device, i.e. that of the subunit, the laser beam can be aligned according to the situation, which was not possible to this extent with known devices for laser transmission welding of plastics.

In particular, the gimbal suspension allows a high degree of freedom of movement for the laser optics, which in turn means that the laser beam can be guided very flexibly in its spatial course.

As an alternative to gimbal suspension, it can be thought of to provide at least one mirror that can be swivelled relative to the platform. Here, for example, an optical arrangement comprising at least one such mirror represents the motion device, with the swivelling mirror representing the subunit. This at least one pivoting mirror serves to reflect the laser beam. It is preferably attached to the platform in a pivotable manner. This can be at least one galvo mirror.

It can be thought of to provide two mirrors pivotable relative to the platform, whereby the laser beam from the laser optics is first reflected at a first mirror and then at a second mirror before it is directed to the welding points or the welding seam. Here it can be considered to arrange the pivot and rotation axes of the mirrors orthogonally to each other in order to be able to effect a wide spectrum of possible spatial orientations of the laser beam.

Numerous other motion devices and subunits can be considered. As explained above using the examples, the subunit is preferably suitable for influencing the spatial course of the laser beam via rotation relative to an imaginary plane within which the platform lies.

A combination of a rotatable element fixed to the platform and a pivoting mirror is also conceivable. For example, the laser optics can be mounted on an element that is fixed to the platform in such a way that it can rotate about an axis relative to the platform. A mirror may also be provided which is rotatable relative to the platform about an axis orthogonal to the axis of rotation of the aforementioned element. Depending on one degree of rotation or deflection of the element with respect to the platform, the laser beam hits another part of the mirror. Again, depending on the degree of rotation of the mirror, the laser beam is reflected differently. By such an arrangement the same result or coverage can be achieved as by an arrangement comprising two mirrors or a cardanic suspension as described above.

The at least one sub-unit, for example the rotatable element described above or the mirror described above, shall be connected to a drive to be moved. In order to keep the weight of the platform as low as possible, it may be advisable not to place these drives on the platform but to connect at least one subunit to the drive via a shaft. It may therefore be thought that at least one shaft is provided, a first end of the shaft being associated with the rotating element or mirror, capable of causing the rotating element or mirror to move, a second end of the shaft being associated with a drive located outside the platform.

The drive may be attached to the base plate or to another location.

The device may include a pyrometer the function of which has already been described in relation to the invention.

The pyrometer may be associated with or attached to the platform. For example, the pyrometer may be used in laser optics.

In order to keep the weight of the platform as low as possible, the pyrometer can also be mounted elsewhere, for example on the base plate. Here, the pyrometer can be connected to one end of an optical fiber, the opposite end of which is fixed to the platform in order to feed the radiation to be measured to the pyrometer.

This can be the same optical fiber that connects the laser outside the platform to the laser optics, or a separate optical fiber.

It should be noted that this invention also includes a system consisting of at least one delta robot as described above and may also include, for example, a pyrometer, at least one drive for the subunit, and other components not attached to the delta robot.

In order to keep the weight of the platform as low as possible, it may be considered that the laser optics comprise half inch components. Half-inch components include, for example, half-inch optics with dimensions of about 12.7 mm.

It can also be considered to manufacture all components of the platform and all components arranged on it from materials that are as light as possible, such as fiber composite materials or other fiber composite materials, in order to save weight.

This invention also generally includes the use of a delta robot for quasi-simultaneous welding of plastics, in particular for quasi-simultaneous laser transmission welding.

### BRIEF DESCRIPTION OF THE DRAWINGS

Further advantages, features and details of the invention result from the following description of preferred execution examples as well as from the drawings; these show in:

FIGS. 1a to 1d each a galvo scanner 9 according to the state of the art in different positions and components to be welded 10, 11

FIGS. 2a to 2d each a laser optic 2 of a device according to the invention, in different positions, as well as components to be welded 10, 11

FIG. 3 an example of an inventive device comprising a delta robot 1,

FIG. 4 another example of an inventive device comprising a delta robot 1,

FIG. 5 a platform 4 of an example of the execution of an inventive device comprising a gimbal suspension, and

FIG. 6 a platform 4 of another example of a device according to invention comprising two mirrors 15.1, 15.2.

### DETAILED DESCRIPTION

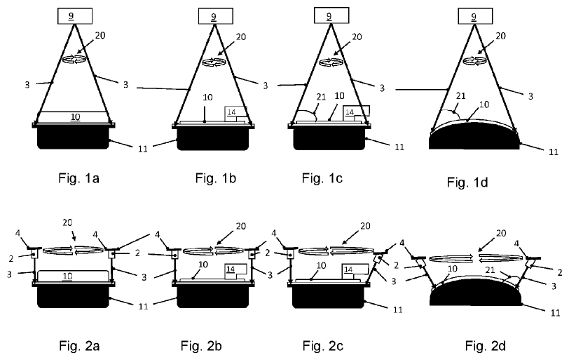

The FIGS. 1a to 1d each show a galvo scanner 9. The course of a laser beam emanating from it in two different positions of the galvo scanner 9 is indicated by an arrow 3. Furthermore, a laser-transparent component 10 and a laser-absorbing component 11 are shown.

The FIGS. 2a to 2d each show a laser optic 2. The course of a laser beam emanating from it in two different positions of the laser optics 2 is indicated by an arrow 3. A laser-transparent component 10 and a laser-absorbing component 11 are also shown.

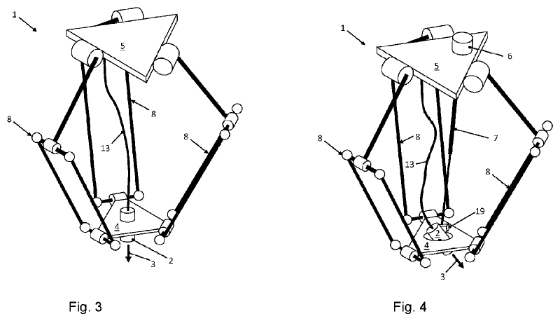

FIG. 3 shows the delta robot 1 comprising a base plate 5, three arms 8 and a platform 4. Delta robots 1 are known, therefore the detailed representation and designation of the rotatory drives, the joints and other known components was omitted.

A laser optic 2 is attached to platform 4, which is connected via an optical conductor 13 to a laser attached to the base plate 5 and not visible in the drawing.

The embodiment according to FIG. 4 differs from the embodiment according to FIG. 3 only in that the laser optics 2 is not connected to the platform 4 in a rotationally fixed manner, but is rotatably assigned to a motion device which is not further depicted via a subunit 19. The subunit 19 is connected to a drive 6 via a shaft 7.

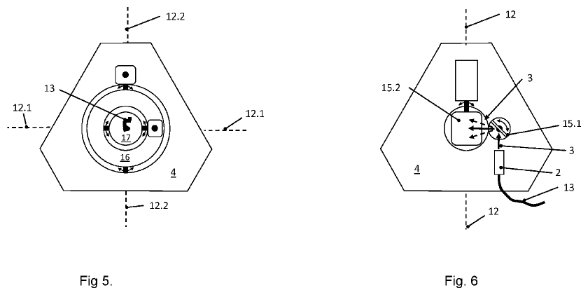

FIG. 5 shows a platform 4 of a embodiment of an inventive device with a gimbal suspension comprising an outer ring 16 and an inner ring 17. The optical conductor 13 is recognizable approximately in the middle of the inner ring 17, the laser optics are not recognizable due to the perspective of FIG. 5.

FIG. 6 shows a platform 4 of another example of an inventive device comprising two mirrors 15.1, 15.2. The laser optics 2 with the optical conductor 13 are recognizable.

With reference to FIGS. 1 to 6, the function of the device according to the invention is explained as follows:

The well-known galvo scanner 9 according to FIGS. 1a to 1d can align the laser beam, which is indicated by arrow 3, or influence its spatial course, by swivelling at least one mirror that does not belong to the galvo scanner 9 and is not shown in detail. This is indicated by arrows 20.

In the FIGS. 1a to 1d, welding points or a welding seam should be created at the points where the arrows 3 hit the components 10, 11.

In FIG. 1a, the laser-transparent component 10 comprises a high component wall, resulting in beam shading, which in turn impairs the laser welding method.

In the arrangements according to FIGS. 1b and 1c, the laser-transparent component 10 comprises a connection 14 which is arranged next to (FIG. 1b) or above (FIG. 1c) an imaginary weld seam in such a way that a beam shading also occurs. A distance to be traversed by the laser beam is much larger in the case of such a beam shading through connection 14 than the distance to be traversed at other points of the laser-transparent component 10. Furthermore, the laser beam can be refracted through any curved walls of connection 14. It is therefore not possible to carry out the laser welding method in such a way that the laser beam simply passes through port 14 at the appropriate points in order to produce the weld seam.

In the arrangement shown in FIG. 1d, the components 10, 11 are convex, which leads to an unfavourable angle of incidence of the laser beam indicated by arrow 3. In comparison to FIG. 1c, for example, FIG. 1d clearly shows that the angle of incidence or the angle 21 at which the laser beam 3 impinges on the components 10, 11 is significantly smaller. The same applies to a comparison with FIGS. 1a and 1b, in which angle 21 is not shown for the sake of clarity.

As shown in FIGS. 2a to 2d, the inventive device overcomes the problems shown in FIGS. 1a to 1d.

Laser optics 2 can take the positions shown in FIGS. 2a and 2b because it is attached to platform 4. This makes it possible to position the laser optics 2 above the components 10, 11 by corresponding movement of the platform 4 in such a way that the laser beam indicated by the arrows 3 impinges essentially perpendicularly on an interface between the laser-transparent component 10 and the laser-absorbing component 11, as shown in FIGS. 2a and 2b. Thus, neither a high component wall of the laser-transparent component 10 shown in FIG. 2a nor a connection 14, which is arranged next to the weld seam to be produced according to FIG. 2b, leads to a beam shading.

FIGS. 2c and 2d show that a movement of the laser optics 2, which for example can be caused by a subunit 19 of a motion device (not shown), helps to overcome the problems shown in the corresponding FIGS. 1c and 1d.

FIGS. 2c and 2d show that the spatial course of the laser beam can be influenced not only by the spatial orientation or movement of platform 4, but also by a movement of laser optics 2 relative to platform 4. Thus, the connection 14 in FIG. 2c arranged above the weld seam does not present a problem either, because a combination of movement of platform 4 and movement of laser optics 2 in relation to platform 4 results in no beam shading.

The same applies to the convex components 10, 11 in FIG. 2d, so that the angle 21, in contrast to the corresponding angle 21 in FIG. 1d, is much closer to a preferred right angle.

As can be seen from FIGS. 2a to 2d, platform 4 of the not shown Delta robot always lies in the same imaginary plane and does not incline, regardless of its position. This is due to the parallel kinematics of the delta robot.

It should be noted that instead of moving the laser optic 2 relative to platform 4 as shown in FIGS. 2c and 2d, it may also be thought of deflecting the laser beam through at least one mirror without moving the laser optic 2. An arrangement comprising at least one mirror can achieve the same result as shown in FIGS. 2c and 2d.

The forms of execution of the present invention shown in FIGS. 3 and 4 are suitable for carrying out the operations shown in FIGS. 2a to 2d by moving arms 8 and, if necessary (FIG. 4), laser optics 2 in relation to platform 4. It should be mentioned here that the laser beam indicated by arrow 3 is generated by a laser arranged below the base plate 5 and therefore not visible in FIGS. 3 and 4, the laser optics 2 being connected to the laser via an optical conductor 13.

The subunit 19, which in the arrangement shown in FIG. 4 causes the movement of the laser optics 2 relative to the platform 4, is driven by a shaft 7, which is connected to a drive 6.

By not placing the laser and drive 6 on platform 4, the weight of platform 4 can be kept as low as possible.

With respect to FIG. 3, it should be noted that the laser beam indicated by arrow 3 is always at a certain angle to platform 4, since the laser optics 2 are rotationally fixed to platform 4. However, this does not have to be a right angle as in the embodiment according to FIG. 3, according to which the laser beam is orthogonal to an imaginary plane within which the platform 4 lies.

In the form shown in FIG. 5, the (not visible) laser optic 2 is fixed to the inner ring 17 of the gimbal suspension. By rotating the outer ring 16 around the rotation axis 12.2 and rotating the inner ring 17 around the rotation axis 12.1, it is possible to move the laser optics 2 with respect to the imaginary plane within which the platform 4 lies. As already described, the spatial course of the laser beam can thus be influenced.

The rotation around the rotation axes 12.1, 12.2 is indicated by arrows. Cardanic suspensions and their function are sufficiently known from the state of the art. The rotation of the rings 16, 17 preferably takes place via one shaft each (not shown), so that the associated drive, which causes the rotation, does not have to be arranged on platform 4.

In the version shown in FIG. 6, the laser optic 2 is rotationally fixed to the platform 4. In order to nevertheless change the spatial orientation of the laser beam relative to platform 4, it is directed onto a first mirror 15.1, reflected by it and then directed onto a second mirror 15.2, from which it is also reflected. By rotating the first mirror 15.1 around an axis of rotation orthogonal to the platform plane (not shown, indicated by a double arrow next to the mirror 15.1), the beam can be directed, indicated by arrows 3, to different sections or locations of the second mirror 15.2. Two alternative courses are indicated by dashed arrows 3, which start from the first mirror 15.1. The second mirror 15.2 can rotate around the rotation axis 12 and thus deflect the beam again, depending on the rotation performed. The arrangement shown in FIG. 6 as well as the arrangement shown in FIG. 5 allows to change the course of the laser beam relative to platform 4.

The mirrors 15.1, 15.2. are preferably galvo mirrors.

### REFERENCE NUMBER LIST

1—Delta robot
2—Laser optics
3—Arrow
4—Platform
5—Base plate
6—Drive
7—Shaft
8—Arm
9—Galvo Scanner
10—Laser transparent component
11—Laser-absorbing component
12—Rotary axis
13—Optical conductor
14—Connection
15—Mirrors
16—Outer ring
17—Inner ring
18—Rotary axis
19—Subunit
20—Arrow
21—Angle

1. Method for quasi-simultaneous welding of at least two welding locations with a laser beam, wherein
the laser beam emanates from a laser optic which is associated with a platform of a delta robot and is guided by a movement of this platform.

2. Method according to claim 1, wherein the laser beam is guided by a combination of the movement of the platform and a further movement which is effected by a motion device associated with the platform.

3. Method according to claim 2, wherein at least one subunit of the motion device is moved relative to the platform in order to effect the further movement.

4. Method according to claim 3, wherein the at least one subunit is moved by a shaft.

5. Method according to claim 2, wherein the laser beam is deflected by at least one mirror arranged pivotably relative to the platform.

6. Method according to claim 2, wherein the laser optics are mounted movably relative to the platform in order to guide the laser beam.

7. Method according to claim 1, wherein a temperature of the plastic is measured by means of a pyrometer, a measurement result being used for evaluating and/or regulating the method.

8. Device for quasi-simultaneous welding of plastics,
comprising a delta robot with a platform, wherein the platform being associated with laser optics.

9. Device according to claim 8,
wherein the platform is further associated with a first end of an optical conductor which is connected to the laser optics, a second end of the optical conductor being connected to a laser, this laser being arranged outside the platform.

10. Device according to claim 8, wherein the laser optics is fixed to an element rotatably fixed to the platform.

11. Device according to claim 8, further comprising at least one mirror pivotally arranged relative to the platform.

12. Device according to claim 10, further comprising at least one shaft, a first end of which shaft is associated with the rotatable element or mirror adapted to cause movement of the rotatable element or mirror, a second end of which shaft is associated with a drive arranged outside the platform.

13. Device according to claim 8, further comprising a pyrometer.

14. Device according to claim 8, wherein the laser optics comprises half inch components.

15. Method according to claim 1, wherein the delta robot for quasi-simultaneous welds plastics.
